(19) United States
(12) Patent Application Publication
(10) Pub. No.: US 2019/0340547 A1
(43) Pub. Date: Nov. 7, 2019

(54) RECORDING MEDIUM RECORDING PROGRAM MANAGEMENT PROGRAM AND INFORMATION PROCESSING APPARATUS

(71) Applicant: FUJITSU LIMITED, Kawasaki-shi (JP)

(72) Inventors: Tomohiko Maeda, Setagaya (JP); Shusaku Nishiyama, Yokohama (JP); Toshikazu Furui, Kawasaki (JP)

(73) Assignee: FUJITSU LIMITED, Kawasaki-shi (JP)

(21) Appl. No.: 16/512,615

(22) Filed: Jul. 16, 2019

Related U.S. Application Data
(63) Continuation of application No. PCT/JP2017/002257, filed on Jan. 24, 2017.

(51) Int. Cl. G06Q 10/06

(52) U.S. Cl. CPC G06Q 10/06

(57) ABSTRACT

A non-transitory computer-readable recording medium stores t herein a program management program for causing a computer to execute processes including: referring to a storage indicating an execution status of a production support program which is executed using production management data; specifying one or more data items which correspond to a data item not used at execution time of the production support program or a data item whose frequency of use at the execution time of the production support program is a predetermined reference value or less, among data items included in the production management data; and outputting the specified one or more data items.

### CROSS-REFERENCE TO RELATED APPLICATION

This application is a continuation application of International Application PCT/JP2017/002257 filed on Jan. 24, 2017 and designated the U.S., the entire contents of which are incorporated herein by reference.

### FIELD

The embodiments discussed herein are related to a program management program, a program management apparatus, and a program management method.

### BACKGROUND

A manager of a factory improves production efficiency and predicts production on the basis of various production management data collected from a production facility in operation.

Japanese Laid-open Patent Publications No. 2013-33359 and No. 2015-118580 are disclosed as related art.

### SUMMARY

According to an aspect of the embodiments, a non-transitory computer-readable recording medium stores therein a program management program for causing a computer to execute processes including: referring to a storage indicating an execution status of a production support program which is executed using production management data; specifying one or more data items which correspond to a data item not used at execution time of the production support program or a data item whose frequency of use at the execution time of the production support program is a predetermined reference value or less, among data items included in the production management data; and outputting the specified one or more data items.

The object and advantages of the invention will be realized and attained by means of the elements and combinations particularly pointed out in, the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example and a process example of a program management apparatus according to a first embodiment;

FIG. 2 is a diagram illustrating a configuration example of a production support system according to a second embodiment;

FIG. 3 is a diagram illustrating a hardware configuration example of a production support server;

FIG. 4 is a block diagram illustrating a configuration example of process functions provided in a production management server;

FIG. 5 is a diagram illustrating a data configuration example of a production management database accumulated on the production management server;

FIG. 6 is a block diagram illustrating a configuration example of process functions provided in a data accumulation server;

FIG. 7 is a diagram illustrating a data configuration example of the production management database accumulated on the data accumulation server;

FIG. 8 is a block diagram illustrating a configuration example of process functions provided in the production support server;

FIG. 9 is a diagram illustrating a data configuration example of a user management database;

FIG. 10 is a diagram illustrating a data configuration example of an application management database;

FIG. 11 is a diagram (part 1) illustrating a process example by a production support program for visualizing progress record of a production step;

FIG. 12 is a diagram (part 2) illustrating a process example by the production support program for visualizing progress record of a production step;

FIG. 13 is a diagram (part 1) illustrating a process example by the production support program for visualizing change in production quantity per unit time;

FIG. 14 is a diagram (part 2) illustrating a process example by the production support program for visualizing change in production quantity per unit time;

FIGS. 15A and 15B are diagrams illustrating process examples by, the production support program for correcting, a deviation of a component mounting position;

FIG. 16 is a diagram illustrating an example of substitute items;

FIG. 17 is a flowchart illustrating a first process example in a use support service;

FIGS. 18A to 18D are diagrams illustrating screen display examples on a terminal device in the first process example;

FIG. 19 is a flowchart illustrating a second process example in the use support service;

FIG. 20 is a diagram illustrating a screen display example on the terminal device in the second process example;

FIG. 21 is a block diagram illustrating a configuration example of process functions provided in a production support server of a third embodiment;

FIG. 22 is a flowchart illustrating a process example in a production support service;

FIG. 23 is a block diagram illustrating a configuration example of process functions provided in a production support server of a fourth embodiment;

FIG. 24 is a flowchart illustrating a process example in a developer support service; and

FIG. 25 is a diagram illustrating a screen display example on a developer terminal by the developer support service.

### DESCRIPTION OF EMBODIMENTS

For example, an application programs for supporting such work by the manager is used. Execution of an application program provides the manager with useful information for the efficiency improvement and the production prediction on the basis of the production management data.

For example, an application creation system in which parameters are set according to a use result of a program element for each user, and a method for presenting a program element is changed depending on which user an application is to be provided is provided. For example, an information processing apparatus that adjusts a display position of an input item on an operation screen on the basis of an operation position of a pointing device and the number of times of use for each input item for each user is provided.

By the way, as described above, at the execution time of the application programs for supporting the work of the manager of a factory, the production management data collected from the production facility is referenced. Here, the production management data is data dependent on a production facility. Therefore, a developer of the application program develops the application program useful for the user while assuming the production facility on the user side of the application program and what kind of production management data is collected from the production facility.

However, since the status of the production facility on the user side of the application program varies, the way of use of the production management data may differ from the developer's assumption at the actual execution time of the application program. Therefore, an accurate analysis of the use status of production management data at the execution time of the application program is an objective for developing the application program useful for many users.

For example, a program management program, a program management apparatus, and a program management method capable of analyzing a data use status at execution time of a production support program may be provided.

Hereinafter, embodiments of the present invention will be described with reference to the drawings.

### First Embodiment

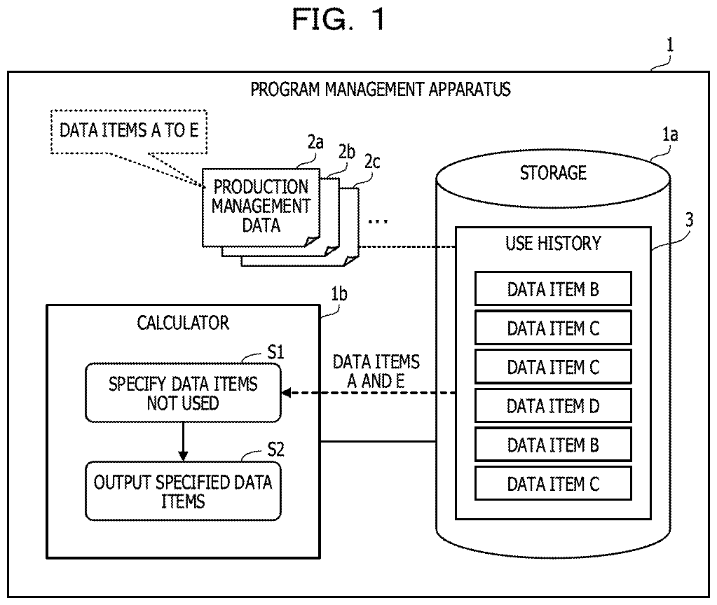

FIG. 1 is a diagram illustrating a configuration example and a process example of a program management apparatus according to a first embodiment. A program management apparatus 1 illustrated in FIG. 1 executes a process for managing a production support program. The production support program is a program used by a user such as a manager of a factory that produces a product such as an industrial product, parts, food, or a plant or a planner of a production plan. The production support program is used by the user to give the user various supports regarding production, such as management of production steps, work to streamline production, prediction of production, and planning of a production plan based on the prediction.

When the production support program is executed, production management data of the user is used (referred to). The production management data is, for example, data acquired along with the operation of the user's factory. The production management data includes at least one or more sets of a data item and a data value corresponding to the data item. What kind of data item is included in the production management data depends on a status of a production facility in the factory where the production management data is acquired.

In the example in FIG. 1, it is assumed that production management data 2a, 2b, 2c, and the like are acquired by a plurality of respective users who uses the production support program. Further, it is assumed that data items A to E are included in the whole of the production management data 2a, 2b, 2c, and the like.

The program management apparatus 1 includes a storage 1a and a calculator 1b. The storage 1a is realized as, for example, a storage area of a storage device provided in the program management apparatus 1. The calculator 1b is realized as, for example, a processor provided in the program management apparatus 1. In this case, the processor executes a predetermined program to realize processes of the calculator 1b.

The storage 1a stores information indicating an execution status of the production support program. This information includes information about which data item's data value has been used (referred to) with execution of the production support program when the production support program is used by, for example, one or more users other than the above-described users.

In the example in FIG. 1, the storage 1a stores a use history 3 of the data item at the execution time of the production support program as the information indicating the execution status of the production support program. In the example in FIG. 1, the data items having been used in an order of B, C, C, B, and C at the execution of the production support program is registered in the use history 3.

The calculator 1b refers to the storage 1a to specify data items not used at the execution time of the production support program among the data items A to E included in the production management data 2a, 2b, 2c, and the like (step S1). In the example in FIG. 1, the data items A and E are specified on the basis of the use history 3. Then, the calculator 1b outputs the data items A and E specified in step S1 (step S2).

By such a process, the calculator 1b can analyze a data use status at the execution time of the production support program. Then, the calculator 1b can specify and output the data items that have not been actually used from among the data items included in the production management data 2a, 2b 2c, and the like.

Further, in step S1, the calculator 1b may specify data items whose frequency of use at the execution time of the production support program is a predetermined reference value or less among the data items A to E included in the production management data 2a, 2b, 2c, and the like. In this case, the calculator 1b can specify and output data items whose use frequency is low from among the data items included in the production management data 2a 2b, 2c, and the like as an analysis result of the data use status.

In any case, the calculator 1b can specify and output data items with a low possibility of use at the execution time of the production support program as an analysis result of the data use status.

The specified data items are output to, for example, a developer of the production support program. In this case, the developer can use the specified data items for future development of the production support program. For example, the developer can improve process content of the production support program so as to conform to usage of the production management data 2a, 2b, 2c, and the like for the user side at the execution time of the production support program. As a result, the developer can develop the production support program useful for the user side.

Further, the specified data items are output to, for example, the manager of the production support program. For example, a case can be considered, in which the manager sets a desirable data item that needs to be acquired on the user side as a use condition of the user for using the production support program. In this case, if the data item with a low possibility of being actually used is set in the use condition, there is a possibility that a user who does not satisfy the use condition may be included in users who can actually use the production support program without any problem. In this case, the user is deprived of a chance to use the production support program, and use of the production support program may not be facilitated.

The manager acquires an output result of the program management apparatus 1, thereby correcting the use condition of the production support program on the basis of the acquired output result, for example. In this case, the use condition of the production support program can be eased and the number of users who use the production support program can be increased.

### Second Embodiment

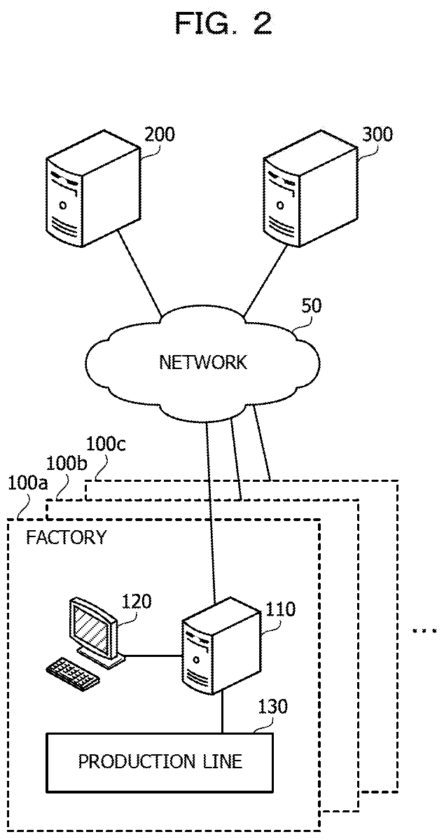

FIG. 2 is a diagram illustrating a configuration example of a production support system according to a second embodiment. The production support system illustrated in FIG. 2 is a system in which a company or an organization having a factory is a user, and a service for supporting a production activity in the factory by the user is provided. FIG. 2 illustrates factories 100a, 100b, 100c, and the like respectively corresponding to individual users as an example. Each of the factories 100a, 100b, 100c, and the like may be a factory that manufactures various industrial products or parts, or a factory that manufactures plants, agricultural products, or food, for example.

Each of the factories 100a, 100b, 100c, and the like includes a production management server 110, a terminal device 120, and a production line 130. The production management server 110 of each of the factories 100a, 100b, 100c, and the like is connected to a data accumulation server 200 and a production support server 300 via a network 50. Further, communication between the data accumulation server 200 and the production support server 300 is also possible via the network 50.

The production management server 110 manages a progress of production in the production line 130 according to data indicating the production plan. At this time, the production management server 110 accumulates various data measured along with production in a production management database. In the following description, data accumulated in the production management database may be described as “production management data”. The production management data includes at least a pair of a measurement item and a measurement value of the measurement item, and indicates, for example, a progress status of production, a state of a manufacturing machine, or the like.

Further, the production management server 110 has a function to cause the user to receive a production support service provided by the production support server 300. The production support service is a service for supporting the production activity of the user, and may include services such as visualization of a production status, provision of statistical information in the production activity, indication of problems or improvement points in the production activity, and adjustment of a production facility. The production support service is realized by an application program provided by the production support server 300. Hereinafter, this application program is called “production support program”.

In the present embodiment, as an example, the production support program is executed in the production support server 300, and a process result is provided to the production management server 110. A production manager or a production plan planner of the factory instructs the production support server 300 to execute the production support program using the terminal device 120 via the production management server 110, and recognizes the process result via a display device of the terminal device 120 or the like.

Furthermore, the production management server 110 can receive a use support service for supporting use of the production support program from the production support server 300. The use support service includes, for example, a service that notifies the user of which production support program can be provided using the production management data accumulated by the user and recommends the user use of the production support program. The production management server 110 has a function to upload the production management data accumulated in the production management server 110 to the data accumulation server 200 so as to cause the user to receive the use support service.

The terminal device 120 is connected to the production management server 110 and is operated by an operator on the user side such as the production manager or the production plan planner. The operator can receive the production support service or the use support service of the production support program via the terminal device 120.

The production line 130 produces a product under the control of the production management server 110. In addition, the production line 130 includes, for example, various sensors, and transmits detection values detected by the sensors in the process of production to the production management server 110. The production line 130 is merely an example of production facility provided in the factory, and the factory that can receive the production support service of the present embodiment is not limited to a factory adopting a line production method.

The data accumulation server 200 collects production management data accumulated in each of the factories 100a, 100b, 100c, and the like and accumulates the production management data in a database. Further, the data accumulation server 200 provides the production management data accumulated in the database in response to a request from the production support server 300.

The data accumulation server 200 may be, for example, a server that provides a platform for making the production management data collected from a large number of factories available to various service providers. In this case, the data accumulation server 200 has an authentication function for connection with the production management server 110 of each factory as a data collection source or a server on the service provider side. Further, the production support server 300 is positioned as one of servers on the service provider side.

The production support server 300 executes the production support program to provide the production support service to the user. For example, the production support server 300 acquires production management data collected from the user from the data accumulation server 200. Then, the production support server 300 executes the production support program, provision of which has been requested by the user, using the acquired production management data, and transmits a process result to the production management server 110 of the user.

Further, the production support server 300 provides the use support service of the production support program to the user. For example, the production support server 300 provides the following service to the user who has not received the production support service. The production support server 300 selects the production support program recommended to the user. The production support server 300 also acquires the production management data collected from the user from the data accumulation server 200. Then, the production support server 300 determines whether data desirable for execution of the selected production support program has already been measured by the production management server 110 of the user on the basis of content of the acquired production management data.

In a case where the desirable data has already been measured, the production support server 300 notifies the user that the selected production support program is available. On the other hand, in a case where there is data insufficient for use of the selected production support program, the production support server 300 notifies the user of an item of the insufficient data to show the user that a new production support program becomes available by further acquiring the data of the item.

In this manner, the production support server 300 can show the user the available production support program, using the measurement item measured by the production management server 110 of the user and can recommend use of the production support program. Further, the production support server 300 can show the user the production support program that becomes available by increasing the measurement item together with the measurement item to be increased and can recommend use of the production support program. Furthermore, the production support server 300 can recommend another production support program to the user who has already used the production support program.

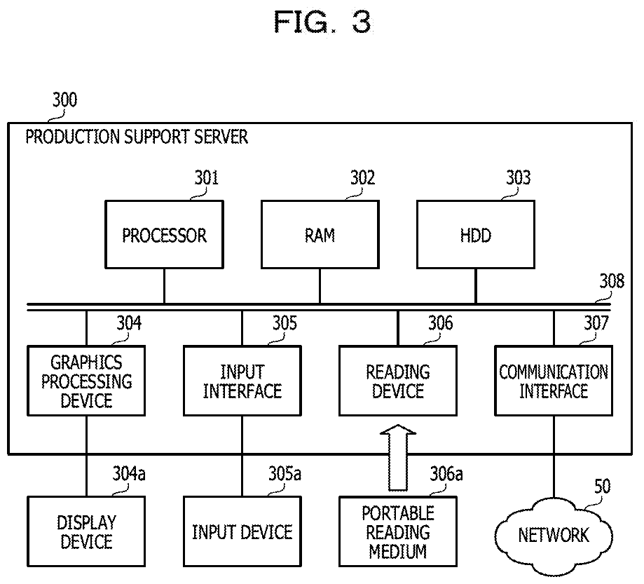

FIG. 3 is a diagram illustrating a hardware configuration example of the production support server. The production support server 300 according to the second embodiment is realized as, for example, a computer as illustrated in FIG. 3.

The entire production support server 300 is controlled by a processor 301. The processor 301 may be a multiprocessor. The processor 301 is, for example, a central processing unit (CPU), a micro processing unit (MPU), a digital signal processor (DSP), an application specific integrated circuit (ASIC), or a programmable logic device (PLD). Further, the processor 301 may be a combination of two or more elements of a CPU, an MPU, a DSP, an ASIC, and a PLD.

A random access memory (RAM) 302 and a plurality of peripheral devices are connected to the processor 301 via a bus 308.

The RAM 302 is used as a main storage device of the production support server 300. The RAM 302 temporarily stores at least a part of an operating system (OS) program and an application program to be executed by the processor 301. The RAM 302 further stores various data used in processes by the processor 301.

As the peripheral devices connected to the bus 308, there are a hard disk drive (HDD) 303, a graphic processing device 304, an input interface 305, a reading device 306, and a communication interface 307.

The HDD 303 is used as an auxiliary storage device of the production support server 300. The HDD 303 stores an OS program, an application program, and various data. As the auxiliary storage device, another type of non-volatile storage device such as a solid state drive (SSD) can be used.

A display device 304a is connected to the graphic processing device 304. The graphic processing device 304 causes the display device 304a to display an image according to a command from the processor 301. Examples of the display device 304a include a liquid crystal display, and an organic electroluminescence (EL) display.

An input device 305a is connected to the input interface 305. The input interface 305 transmits a signal output from the input device 305a to the processor 301. Examples of the input device 305a include a keyboard and a pointing device. Examples of the pointing device include a mouse, a touch panel, a tablet, a touch pad, and a track ball.

A portable recording medium 306a is attached to and detached from the reading device 306. The reading device 306 reads data recorded on the portable recording medium 306a and transmits the data to the processor 301. Examples of the portable recording medium 306a include an optical disc, a magneto-optical disc, and a semiconductor memory.

The communication interface 307 transmits and receives data to and from other devices such as the production management server 110 and the data accumulation server 200 via the network 50.

Process functions of the production support server 300 can be realized with the above hardware configuration. The production management server 110 and the data accumulation server 200 can also be realized as the computer as illustrated in FIG. 3.

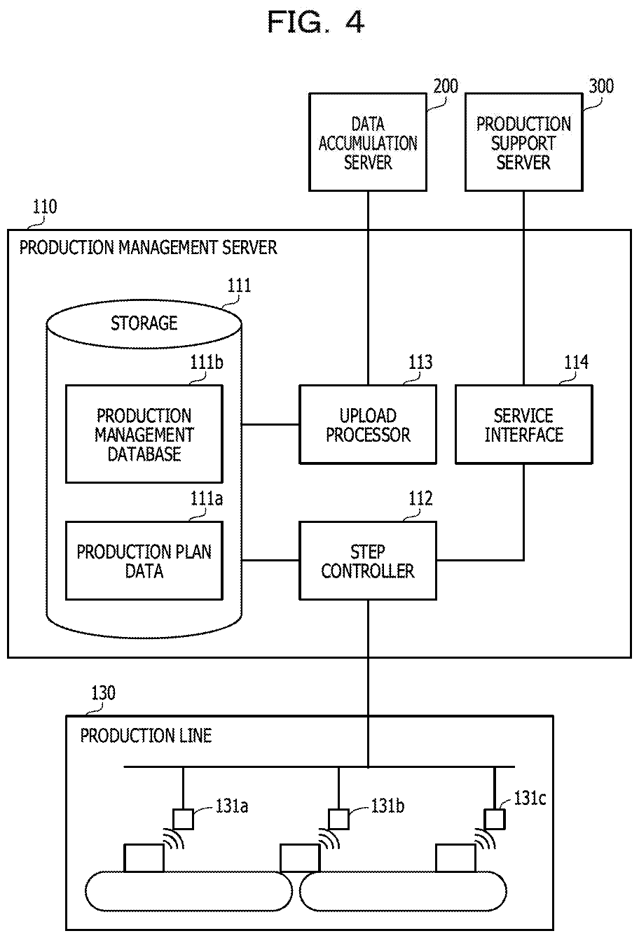

FIG. 4 is a block diagram illustrating a configuration example of process functions provided in the production management server. The production management server 110 includes a storage 111, a step controller 112, an upload processor 113, and a service interface 114. The storage 111 is implemented as, for example, a storage area of a storage device provided in the production management server 110. Processes of the step controller 112, the upload processor 113, and the service interface 114 are realized by, for example, execution of a predetermined program by a processor provided in the production management server 110.

The storage 111 stores production plan data 111a and a production management database 111b. The production plan data 111a is data for controlling a progress of the production step in the production line 130. The production management database 111b accumulates the production management data acquired from the production line 130. At least one of the production plan data 111a and the production management database 111b may be stored in a storage device connected to an outside of the production management server 110.

The step controller 112 controls the progress of the production step, in the production line 130 on the basis of the production plan data 111a. Further, the step controller 112 acquires the production management data from the production line 130 and stores the data in the production management database 111b. As described above, the production management data is data measured along with production.

For example, as illustrated in FIG. 4, the production line 130 is provided with sensors 131a, 131b, 131c, and the like for detecting the progress status of production and the state of a manufacturing machine. The step controller 112 acquires detection data from the sensors 131a, 131b, 131c, and the like, controls the progress of steps on the basis of the acquired detection data, and stores the acquired detection data in the production management database 111b as the production management data. Examples of such detection data include a temperature detected by a temperature sensor, a current in the apparatus, a value of a voltage, count values indicating the numbers of times of detection by a proximity sensor and a light cutting sensor, and reading results and reading times of barcodes attached to products or parts flowing in the production line 130.

Further, the step controller 112 can perform predetermined calculation on the basis of the detection data acquired from the production line 130 and store a calculation result in the production management database 111b as the production management data. For example, the step controller 112 can calculate the number of productions and the number of defects per hour in a certain manufacturing step for a certain product on the basis of a completion time of the manufacturing step and store the calculation result in the production management database 111b. Alternatively, the step controller 112 can calculate a positional deviation amount of a mount position of a certain product in a certain manufacturing step and a variation in the position on the basis of a detection result of the mount position and store the calculation result in the production management database 111b.

In this way, the detection data obtained from the production line 130 and the data calculated from the detection data are accumulated in the production management database 111b in each factory. In the following description, a value of the detection data detected from the sensor or a value calculated from the value of the detection data in this way is described as “measurement value”.

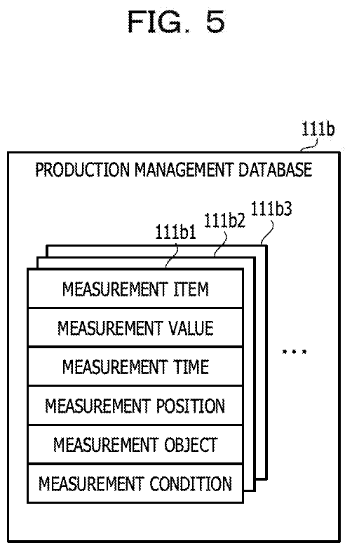

Here, FIG. 5 is a diagram illustrating a data configuration example of the production management database accumulated on the production management server. In each of records 111b1, 111b2, 111b3, and the like of the production management database 111b, a measurement item, a measurement value, a measurement time, a measurement position, a measurement object, and measurement conditions are registered.

The measurement item indicates what kind of information the measurement value is. The measurement value is a value corresponding to the measurement item, and indicates, for example, the detection value by the sensor of the production line 130 or a value calculated on the basis of the detection value. The measurement time indicates a time when the measurement value has been measured. The measurement position indicates a position on the production line 130 at which the measurement value has been measured and a measured step. In a case where a plurality of the production lines 130 exist in the same factory, the measurement position may indicate identification information of the production line 130. The measurement object indicates information identifying an object product for which the measurement value has been measured. For example, the measurement object indicates an ID, a lot number, an order number, and the like, of the product. The measurement conditions indicate conditions under which the measurement value has been measured. For example, the measurement conditions indicate a sampling period (acquisition frequency) of the measurement value, a resolution of the measurement value, and the like.

Hereinafter, description will be given referring back to FIG. 4.

The upload processor 113 uploads the production management data accumulated in the production management database 111b to the data accumulation server 200. At that time, the upload processor 113 converts the stored production management data into data in a predetermined format, for example, and uploads the data to the data accumulation server 200. For example, the production management data is converted into data in an extensible markup language (XML) format or a JavaScript object notation (JavaScript: registered trademark) (JSON) format in which a pair of tag information and a data value is described as text data.

The service interface 114 executes a process for receiving the production support service and the use support service of the production support program from the production support server 300. For example, the production support server 300 functions as a web server for providing these services. In this case, in the terminal device 120 connected to the production management server 110, a web browser operates, and the service interface 114 relays data transmitted or received between the production support server 300 and the web browser of the terminal device 120. For example, the service interface 114 receives data of a web page indicating a process result of each of the above services from the production support server 300, and transmits the data to the terminal device 120. With the reception and transmission, the process result of the service is displayed on the web browser. Further, the service interface 114 can change a control process and setting of the production line 130 by the step controller 112 on the basis of the data transmitted from the production support server 300 by the process of the production support program, for example.

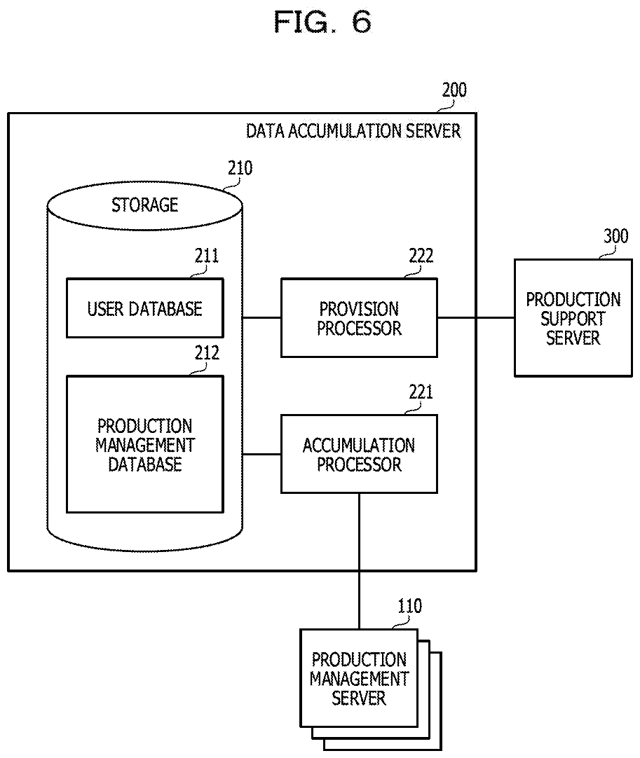

FIG. 6 is a block diagram illustrating a configuration example of process functions provided in the data accumulation server. The data accumulation server 200 includes a storage 210, an accumulation processor 221, and a provision processor 222. The storage 210 is implemented as, for example, a storage area of a storage device provided in the data accumulation server 200. Processes of the accumulation processor 221 and the provision processor 222 are realized by, for example, execution of a predetermined program by a processor provided in the data accumulation server 200.

The storage 210 stores a user database 211 and a production management database 212. The user database 211 stores information for performing user authentication. The user mentioned here includes not only a user who receives the production support service from the production support server 300 but also a user who can acquire the production management data accumulated in the data accumulation server 200. For example, the user database 211 stores information used for user authentication when the production management data is uploaded from the production management server 110 and information used for user authentication when the production management data is requested from the production support server 300. The production management database 212 stores the production management data collected from the production management server 110 of each factory.

Note that at least one of the user database 211 and the production management database 212 may be stored in a storage device connected to the outside of the data accumulation server 200.

The accumulation processor 221 stores the production management data uploaded from the production management server 110 of each factory in the production management database 212. With the storage, the production management data locally accumulated in all the factories are aggregated in the production management database 212 of the data accumulation server 200. Note that the accumulation processor 221 refers to the user database 211 at connection with each production management server 110.

The provision processor 222 reads, from the production management database 212, the production management data requested from the production support server 300, and transmit the read data to the production support server 300. For example, the provision processor 222 can receive a search key such as a user name or a measurement period, from the production support server 300, extract the production management data corresponding to the search key from the production management database 212, and transmit the extracted data to the production support server 300.

Note that the provision processor 222 refers to the user database 211 at connection with the production support server 300. Further, the production management data acquirable by the production support server 300 can be limited for each user or an acquirable range of data can be limited by the user database 211.

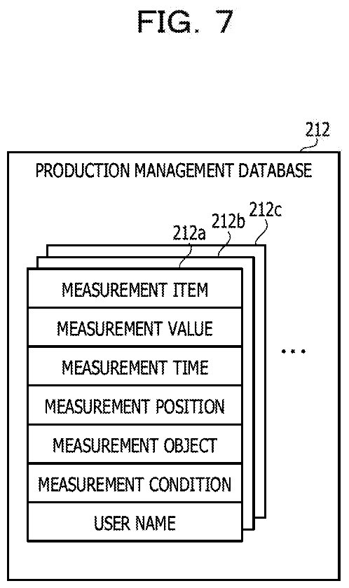

FIG. 7 is a diagram illustrating a data configuration example of the production management database accumulated on the data accumulation server. In each of records 212a, 212b, 212c, and the like of the production management database 212, a user name is registered in addition to the data included in each record of the production management database 111b accumulated in each factory. The user name indicates a user of a transmission source of the data in the record.

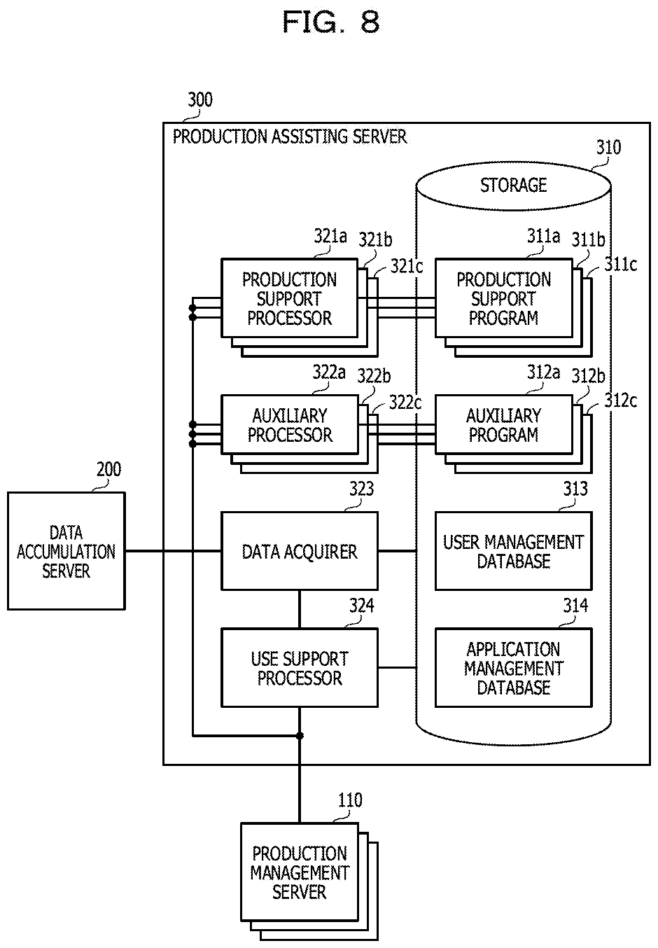

FIG. 8 is a block diagram illustrating a configuration example of process functions provided in the production support server. The production support server 300 includes a storage 310, production support processors 321a, 321b, 321c, and the like, auxiliary processors 322a, 322b, 322c, and the like, a data acquirer 323, and a use support processor 324.

The storage 310 is implemented as, for example, a storage area of a storage device provided in the production support server 300, such as the HDD 303 illustrated in FIG. 3. The storage 310 stores production support programs 311a, 311b, 311c, and the like, auxiliary programs 312a, 312b, 312c, and the like, a user management database 313, and an application management database 314.

The production support programs 311a, 311b, 311c, and the like are application programs for providing the production support service. The auxiliary programs 312a, 312b, 312c, and the like are application programs for executing a process for assisting the process by the production support program. An example of the auxiliary process includes a process of creating the production management data preferable for using the production support program, using another production management data having a different measurement item.

In the user management database 313, the user who receives the production support service and the production support program used by the user are registered in association with each other. In the application management database 314, information of each of the production support programs 311a, 311b, 311c, and the like is registered. For example, in the application management database 314, the measurement item of production management information used (referenced) at the execution time of the production support program is registered.

Processes of the production support processors 321a, 321b, 321c, and the like are realized by execution of the respective production support programs 311a, 311b, 311c, and the like by the processor 301 of the production support server 300. For example, the production support processors 321a, 321b, 321c, and the like are activated by execution of the respective production support programs 311a, 311b, 311c, and the like by the processor 301.

For example, when providing the production support service for a certain user, the production support processor 321a acquires the production management data corresponding to the certain user from the data accumulation server 200 via the data acquirer 323. The production support processor 321a executes a process for supporting a production activity of the user, using the acquired production management data, and transmits a process result to the production management server 110 corresponding to the user.

Processes of the auxiliary processors 322a, 322b, 322c, and the like are realized by execution of the respective auxiliary programs 312a, 312b, 312c, and the like by the processor 301 of the production support server 300. For example, the auxiliary processors 322a, 322b, 322c, and the like are activated by execution of the respective auxiliary programs 312a, 312b, 312c, and the like by the processor 301.

Processes of the data acquirer 323 and the use support processor 324 are realized by, for example, execution of a predetermined program by the processor 301 of the production support server 300.

The data acquirer 323 acquires the production management data preferable for execution of the production support program from the data accumulation server 200. For example, the data acquirer 323 transmits the detection key such as the user name or the measurement period to the data accumulation server 200 to request a search, thereby acquiring data of a record corresponding to the search key from the production management database 212 of the data accumulation server 200.

The use support processor 324 executes a process for providing the use support service of the production support program. For example, the use support processor 324 selects a user and a selects the production support program to be recommended to the user. The use support processor 324 acquires the production management data corresponding to the selected user from the data accumulation server 200 via the data acquirer 323, and specifies measurement items measured in the production management server 110 of the user on the basis of the acquired data. At the same time, the use support processor 324 extracts desirable measurement items used at the execution time of the selected production support program from the application management database 314. Then, the use support processor 324 determines whether the specified measurement items include all the desirable measurement items.

In a case where the specified measurement items include all the desirable measurement items, the use support processor 324 notifies the user that the selected production support program is available. On the other hand, in a case where there is a measurement item insufficient for using the selected production support program, the use support processor 324 notifies the user of the insufficient measurement item. Then, the use support processor 324 shows the user that the, selected production support program becomes available by newly measuring the insufficient measurement item.

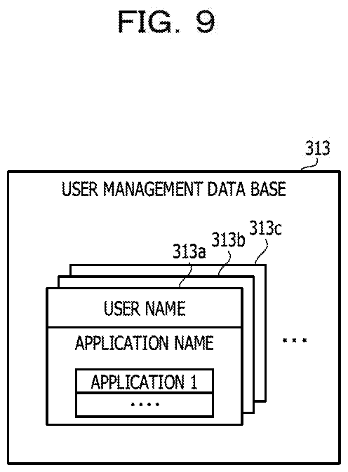

FIG. 9 is a diagram illustrating a data configuration example of the user management database. The user management database 313 includes records 313a, 313b, 313c, and the like according to users. In each of the records 313a, 313b, 313c, and the like, a user name identifying a user, and an application name indicating a production support program available to the user in response to a user request from the user are registered.

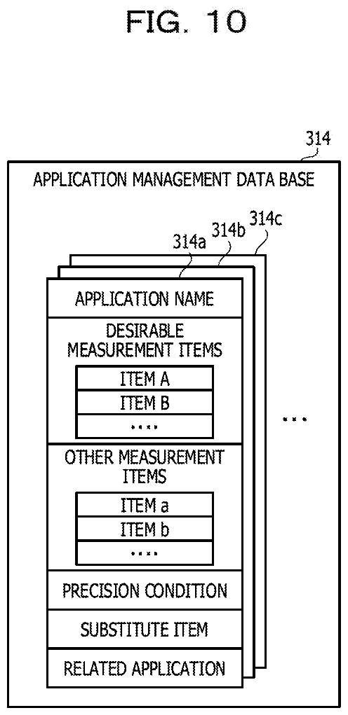

FIG. 10 is a diagram illustrating a data configuration example of the application management database. The application management database 314 includes records 314a, 314b, 314c, and the like according to production support programs. In each of the records 314a, 314b, 314c, and the like, the application name, desirable measurement items, other measurement items, precision conditions, a substitute item, and a related application are registered.

The application name is identification information identifying the production support program. The desirable measurement items indicate desirable measurement items for executing the production support program. The other measurement items indicate measurement items not included in the desirable measurement items, among the measurement items that can be used at the execution time of the production support program. A plurality of measurement items can be registered as both the desirable measurement items and the other measurement items.

The precision conditions indicate conditions of precision of the measurement value available at the execution time of the production support program, for at least one of the measurement items registered as the desirable measurement items or the other measurement items. For example, the measurement item for which the precision conditions are registered can be used at the execution time of the production support program if the measurement value satisfies the precision conditions. The precision referred to here is an index indicating accuracy or reliability of the measurement value. As the precision conditions, conditions of a measurement frequency and a variation of the measurement value are registered, for example.

The substitute item indicates another measurement item available in place of the measurement item designated as the desirable measurement item. The related application indicates an auxiliary program associated with the production support program. For example, as the related application, an auxiliary program capable of creating the measurement value of the desirable measurement item by calculation on the basis of the measurement value of the other measurement item.

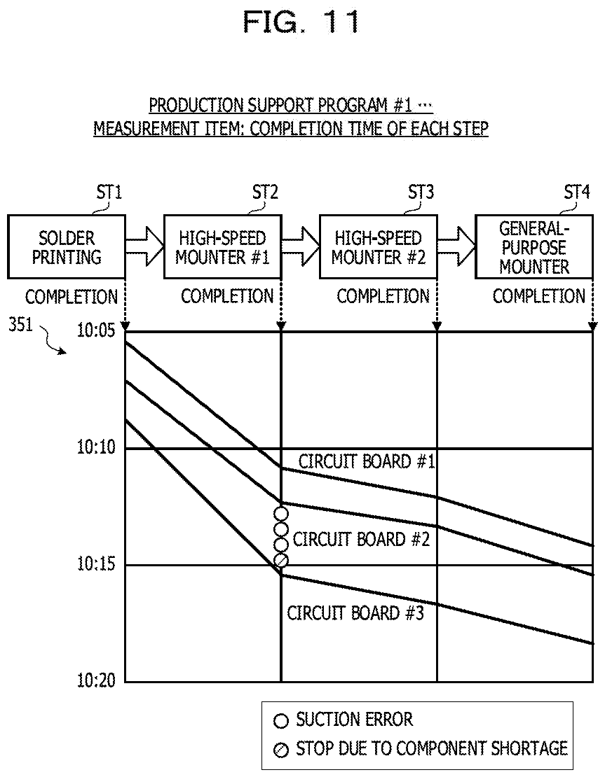

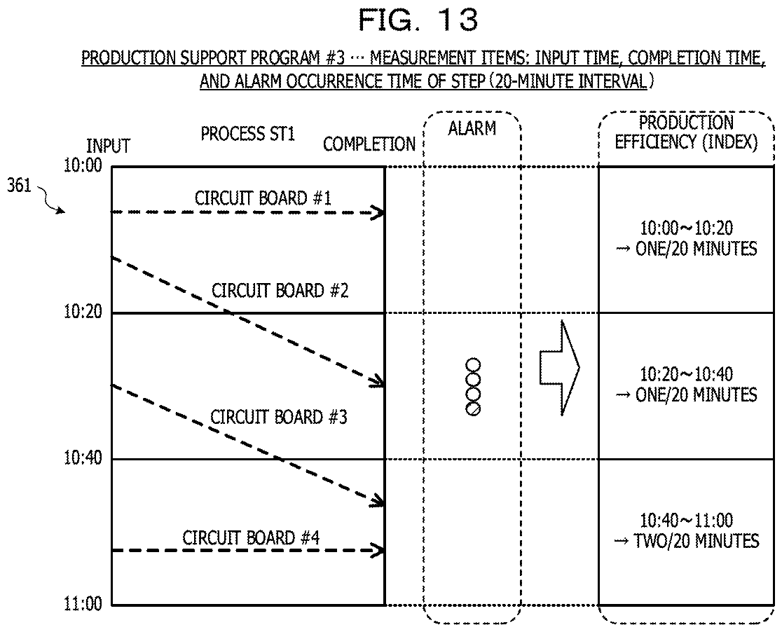

Next, a specific example of the production support service realized by the production support program will be described with reference to FIGS. 11 to 15A and 15B. Further, FIGS. 13 to 15A and 15B illustrate the precision conditions corresponding to the measurement item.

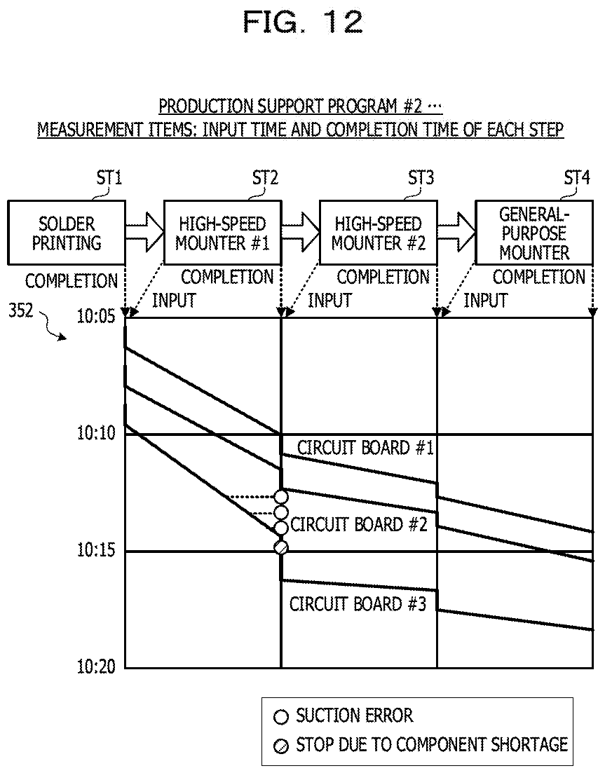

First, FIGS. 11 and 12 are diagrams illustrating process examples by the production support programs for visualizing a progress record of a production step. In FIGS. 11 and 12, it is assumed that the production support programs are applied to steps of mounting components on a printed circuit board, as an example. This mounting step includes steps ST1 to ST4. Step ST1 is a step of performing solder printing on the circuit board. Step ST2 is a step of mounting a component on the circuit board using a high-speed mounter #1. Step ST3 is a step of mounting a component on the circuit board using a high-speed mounter #2. Step ST4 is a step of mounting a component on the circuit board using a general-purpose mounter.

Further, FIG. 11 is a process example by a production support program #1, and FIG. 12 is a process example by a production support program #2. Here, the production support program #2 is a program belonging to the same field as the production support program #1 or a program of the same type but the production support program #2 is more multifunctional than the production support program #1. For example, the production support program #2 corresponds to an upgraded version of the production support program #1.

As illustrated in FIG. 11, a completion time of each of steps ST1 to ST4 for each component is used as the measurement item by the execution of the production support program #1, and a graph 351 illustrated in FIG. 11 is displayed on the terminal device 120. The graph 351 illustrates the progress status of the steps for circuit boards #1 to #3, and the vertical axis represents transition of time and the horizontal axis represents the progress of the step. The completion times of the steps of the same circuit board are connected by a straight line.

According to the graph 351, it is found that the progress of the step for the corresponding circuit board is faster and the production efficiency is higher as the inclination of the straight line is smaller. Therefore, an operator of the terminal device 120 can visually recognize the production efficiency in the mounting step by visually recognizing the graph 351.

Further, as illustrated in FIG. 11, in step ST2, for example, it is assumed that an alarm indicating a suction error and an alarm indicating a stop due to a component shortage are detected. The operator compares an occurrence time of the alarm with the straight line on the graph 351 to estimate which circuit board the alarm has occurred for.

Meanwhile, as illustrated in FIG. 12, at the execution time of the production support program #2, an input time of each of steps ST1 to ST4 for each component is further used as the measurement item. Then, a graph 352 illustrated in FIG. 12 is displayed on the terminal device 120 on the basis of the input time and the completion time of each step. In the graph 352, the completion time of a certain step, the input time of a next step, and the completion time of the same step are sequentially connected by a straight line for the same circuit board.

According to this graph 352, a time between the completion time of a certain step and the input time of the next step appears as a waiting time. Therefore, the operator can recognize not only the production efficiency in each step by the inclination of the straight line but also the magnitude of the waiting time. Further, the operator can confirm whether the alarm has occurred during the input of the step or during the waiting time. In the example in FIG. 12, the operator can recognize that the alarm has occurred during the waiting time between the step ST1 and the step ST2 for the circuit board #3. As described above, the service using the production support program #2 can more finely visualize the progress record of the production process than the service using the production support program #1.

Here, in the record corresponding to the production support program #1 among the records in the application management database 314, the completion time of each step is registered as the desirable measurement item. Meanwhile, in the record corresponding to the production support program #2, the input time and the completion time of each step are registered as the desirable measurement items. As illustrated in FIGS. 11 and 12, the production support program having a larger number of desirable measurement items can provide the production support service that can more finely support the production activity.

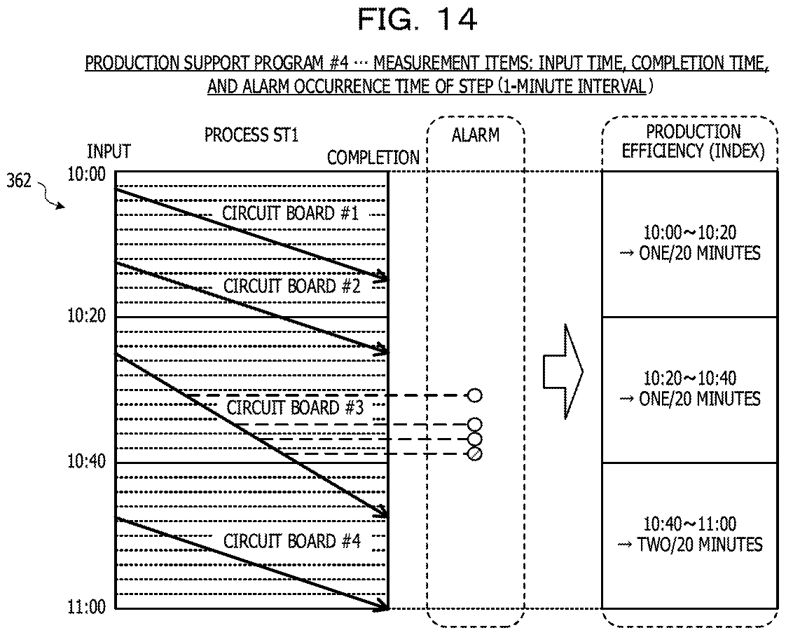

FIGS. 13 and 14 diagrams illustrating process examples by production support programs for visualizing change in production quantity per unit time. FIGS. 13 and 14 illustrate, as an example, cases of visualizing the number of circuit boards input to step ST1 above and the number of circuit boards on which component mounting has been completed in step ST1. FIG. 13 is a process example by a production support program #3, and FIG. 14 is a process example by a production support program #4. Further, it is assumed that the production support program #4 corresponds to an upgraded version of the production support program #2.

At the execution time of both the production support programs #3 and #4, the input time for step ST1 and the completion time in step ST1 for each circuit board and the occurrence time of the alarm are used as the measurement items. For example, the input time, the completion time, and the alarm occurrence time are registered as the desirable measurement items in the records respectively corresponding to the production support programs #3 and #4 among the records in the application management database 314.

However, in the process of the production support program an acquisition interval of the measurement values corresponding to the measurement items may be 20 minutes or less, whereas in the process of the production support program #4, the acquisition interval needs to be 1 minute or less. For example, in the record corresponding to the production support program #3 among the records in the application management database 314, respective acquisition intervals of the input time, the completion time, and the alarm occurrence time being 20 minutes or less is registered as the precision condition. Further, in the record corresponding to the production support program #4, respective acquisition intervals of the input time, the completion time, and the alarm occurrence time being 1 minute or less is registered as the precision condition. As described above, between the production support program #3 and the production support program #4, the desirable measurement items are the same but the precision conditions set for the desirable measurement items are different.

As illustrated in FIG. 13, a graph 361 indicating the progress of the circuit boards #1 to #4 in step ST1 is displayed on the terminal device 120 on the basis of the input times and the completion times respectively corresponding to the circuit boards #1 to #4 by execution of the production support program #3. At the same time, a marker indicating occurrence of an alarm is displayed in association with a time zone of every 20 minutes in the graph 361 on the basis of the alarm occurrence times respectively corresponding to the circuit boards #1 to #4. Furthermore, the number of step completions of every 20 minutes is calculated and displayed as an index indicating the production efficiency in association with the time zone of every 20 minutes in the graph 361. For example, in the time zone from 10:00 to 10:20, an index of 1 for 20 minutes is calculated.

Meanwhile, as illustrated in FIG. 14, a graph 352 indicating the progress of the circuit boards #1 to #4 in step ST1 is displayed on the terminal device 120 on the basis of the input times and the completion times respectively corresponding to the circuit boards #1 to #4 by execution of the production support program #4. At the same time, a marker indicating occurrence of an alarm is displayed in association with a time zone per minute in the graph 362 on the basis of the alarm occurrence times respectively corresponding to the circuit boards #1 to #4. Furthermore, the number of step completions of every 20 minutes is calculated and displayed as an index indicating the production efficiency in association with the time zone of every 20 minutes in the graph 362.

According to the display information in FIG. 13, the operator can visually recognize that the alarm has occurred four times in the time zone from 10:20 to 10:30. However, in this time zone, since both the circuit board #2 and the circuit board #3 are input to the step ST1, the operator may not determine in which of component mounting work between the circuit board #2 and the circuit board #3 the alarm has occurred. In contrast, according to the display information in FIG. 14, the position of the marker indicating the occurrence of the alarm is displayed with a finer resolution of 1 minute. Thus, the operator can determine that the alarm has occurred in the component mounting work of the circuit board #3.

As described above, even if the desirable measurement items used at the execution time of the production support program are the same, the production support services with different support levels for the production activity are provided due to the difference in the precision conditions.

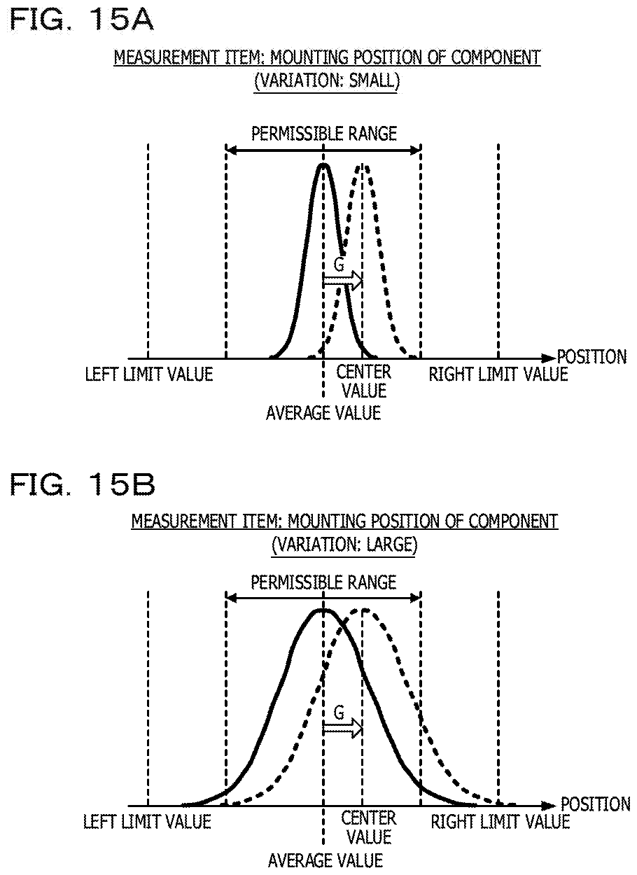

FIGS. 15A and 15B are diagrams illustrating process examples by the production support program for correcting a deviation of a component mounting position. In FIGS. 15A and 1513, as an example, it is assumed that a production support program #5 is applied to the step of mounting a component on a circuit board by a predetermined mounter. At the execution time of the production support program #5, the mounting position of a component on the circuit board is used as the desirable measurement item. For example, in the record corresponding to the production support program #5 among the records in the application management database 314, the mounting position of a component is registered as the desirable measurement item. In FIGS. 15A and 15B, the mounting position of a component is illustrated as a coordinate value in a left-right direction on the circuit board, and this coordinate value becomes larger toward the right side.

A graph illustrating a distribution of the mounting positions of components input to the mounting step in a predetermined time zone by the execution of the production support program #5 is displayed on the terminal device 120. Then, an average value of the mounting positions is calculated, and a deviation amount G indicating how much the average value deviates from a predetermined reference value is calculated. This reference value indicates an ideal reference position when a component is mounted on the circuit board, and the deviation amount G indicates how much an average mounting position of components in the actual mounting step deviates from the ideal reference position.

The operator of the terminal device 120 recognizes the calculated deviation amount G, thereby changing control data of the production line 130 to correct the mounting position of a component on the circuit board by the deviation amount G. Alternatively, the control data of the production line 130 may be automatically corrected by the execution of the production support program #5.

FIG. 15A illustrates an example of a graph in a case where variation in mounting positions is small, and FIG. 15B illustrates an example of a graph in a case where the variation is large. There is a limit to a mountable range of components on the circuit board. FIGS. 15A and 15B illustrate a left limit value indicating a left-side limit position and a right limit value indicating a right-side limit position.

In the case where the variation in mounting, positions is relatively small as illustrated in FIG. 15A, even if the mounting position is moved by the deviation amount G, a coordinate of a mounting position measured after the movement falls between the left limit value and the right limit value. However, even if the calculated deviation amount G is the same as in the case in FIG. 15A, if the variation in mounting positions is large as illustrated in FIG. 15B, a mounting position measured after movement may exceed the mountable range when the mounting position is moved by the deviation amount G. In the example in FIG. 15B, the coordinate of the mounting position exceeds the right limit value after the movement of the mounting position.

For this reason, the variation in the measurement value of the mounting position of a component needs to be equal to or smaller than a fixed value, the measurement value being used at the execution time of the production support program #5. Therefore, in the record corresponding to the production support program #5 among the records in the application management database 314, an index indicating the variation being equal to or smaller than a predetermined value is registered as the precision condition for the mounting position of a component. For example, in FIGS. 15A and 15B, a permissible range centering on the average value of the mounting positions of the measured components is set. Then, variance of the measurement values of the mounting positions falling within the permissible range is registered as the precision condition for the mounting position of a component.

Here, in the above-described examples in FIGS. 13 and FIG. 14, a condition related to the measurement condition of the acquisition interval (acquisition frequency) of the measurement value is set as the precision condition corresponding to the measurement item. Such a measurement condition is set as the measurement condition in the records in the production management database 212. Therefore, the use support processor 324 may just determine whether the measurement value of the measurement item is available at the execution time of the production support program according to whether the measurement condition extracted from the record corresponding to the user satisfies the precision condition.

In contrast, in the examples in FIGS. 15A and 15B, the variation in the measurement value of the measurement item is set as the precision condition. In such a case, the use support processor 324 may just determine whether the measurement value of the measurement item is available at the execution time of the production support program as follows. For example, the use support processor 324 calculates the variation in the measurement values extracted from a plurality of records corresponding to the user, and determines whether the calculated variation satisfies the precision condition.

Next, a substitute item registered in the application management database 314 will be described.

As described above, the use support processor 324 acquires the production management data corresponding to a certain user from the data accumulation server 200 when determining whether the user can use the production support program. Then, the use support processor 324 specifies the measurement items measured in the production management server 110 of the user on the basis of the acquired data. At the same time, the use support processor 324 extracts the desirable measurement items for the production support program from the application management database 314 and determines whether the specified measurement items include all the desirable measurement items.

Here, even in a case where there is an insufficient measurement item for using the production support program, the measurement value of the measurement item may be able to be replaced with the measurement value of another measurement item having nearly equivalent measurement content. Then, when such a substitutable measurement item has been measured by the production management server 110 of the user, the use support processor 324 can determine that the user can use the production support program.

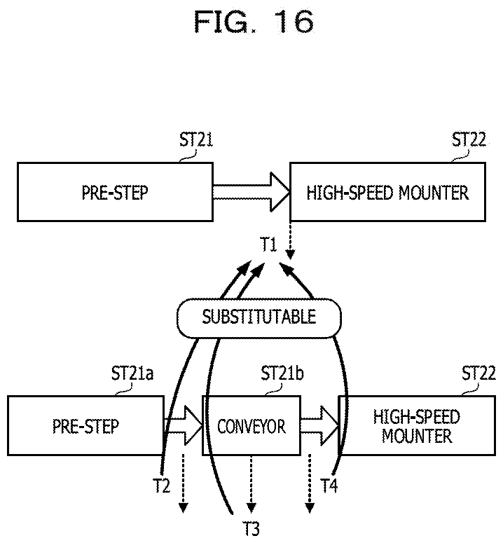

FIG. 16 is a diagram illustrating an example of the substitute item. In FIG. 16, steps ST21 and ST22 included in a step of mounting a component on the printed circuit board are assumed. It is assumed that step ST21 is a pre-step for the step of mounting a component and step ST22 is a step of mounting a component by a high-speed mounter.

For example, it is assumed that an input time T1 of the circuit board for step ST22 is set as the desirable measurement item corresponding to a certain production support program but the input time T1 is not measured in the production management server 110 of a certain user. Meanwhile, as illustrated on a lower side in FIG. 16, step ST21 includes pre-step ST21a and step ST21b in which the circuit board is conveyed to the high-speed mounter by a conveyor. Then, it is assumed that the production management server 110 of the user has measured, as the measurement items, a completion time T2 of step ST21a, a passing time T3 of the circuit board at a predetermined position in step ST21b, and a setting completion time T4 of the circuit board by the conveyor in step ST21b.

In this case, for example, if a transfer time of the circuit board by the conveyor in step ST21b is sufficiently shorter than the time taken to mount a component by the high-speed mounter in step ST22, the input time T1 can be replaced with any of the completion time T2, the passing time T3, and the setting completion time T4.

Next, a process in the use support service of the production support program will be described using a flowchart.

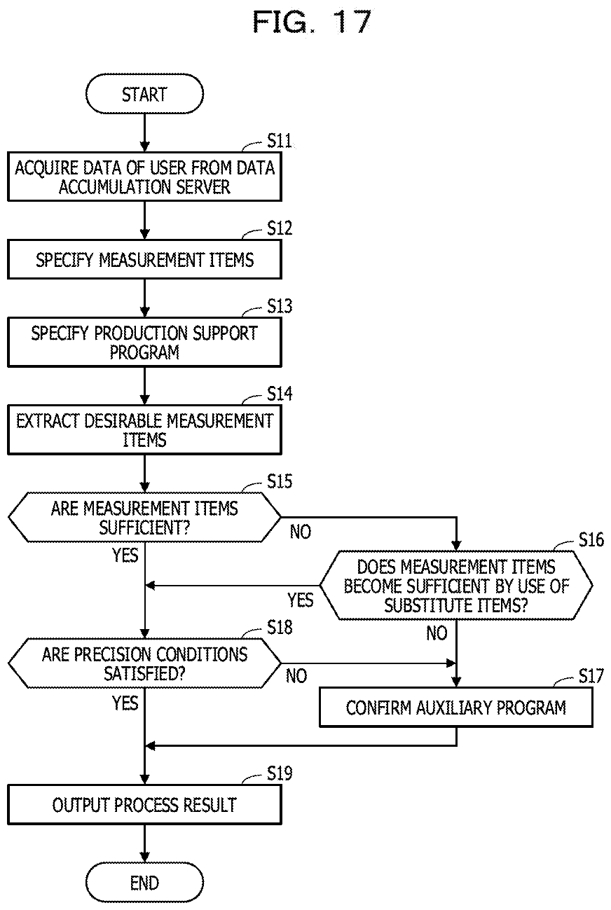

FIG. 17 is a flowchart illustrating a first process example in the use support service. The first processing example illustrates a process in the use support service for providing the user with information based on the determination result of determining whether a specific production support program is available to a specific user.

[step S11] The use support processor 324 of the production support server 300 selects a user to which the use support service is to be provided. Then, the use support processor 324 acquires the production management data corresponding to the selected user from the data accumulation server 200 via the data acquirer 323. For example, the use support processor 324 notifies the user name of the user selected as the search key. The use support processor 324 transmits the notified user name as the search key to the data accumulation server 200 to request a search of the production management database 212. In response to the request, the record corresponding to the user is read from the production management database 212 and the read record is transmitted to the production support server 300. The data acquirer 323 receives and passes the data of the transmitted record to the use support processor 324.

[step S12] The use support processor 324 specifies the measurement items measured by the production management server 110 of the user on the basis of the acquired production management data. For example, the use support processor 324 extracts the measurement items set in the acquired record.

[step S13] The use support processor 324 specifies one production support program to be recommended to the user. For example, in a case where the user has not received the production support service yet, the use support processor 324 selects the production support program related to a business or use of the user. In a case where the user has already received the production support service, a following process is executed, for example. The use support processor 324 extracts one production support program being used by the user by reference to the user management database 313. Then, the use support processor 324 specifies another production support program related to the extracted production support program, for example, a production support program of an upgraded version of the extracted production support program, as the production support program to be recommended to the user.

In step S13, the production support program may be designated by the user side, for example. In this case, the user can inquire of the production support server 300 whether a specific production support program is available using the measurement value of the measurement item currently being measured.

[step S14] The use support processor 324 extracts, from the application management database 314, the desirable measurement items set for the production support program specified in step S13.

[step S15] The use support processor 324 collates the desirable measurement items extracted in step S14 and the measurement items specified in step S12 to determine whether the measurement items of the user are sufficient.

In a case where all the extracted desirable measurement items are included in the measurement items specified in step S12, the use support processor 324 determines that the measurement items are sufficient and executes the process in step S18. On the other hand, in a case where there is the extracted desirable measurement item not included in the measurement items specified in step S12, the use support processor 324 determines that the measurement items are not sufficient and executes the process in step S16.

[step S16] The use support processor 324 extracts, from the application management database 314, the substitute item set for the production support program specified in step S13. Then, the use support processor 324 determines whether the next conditions are satisfied.

The use support processor 324 first determines whether the substitute items have been able to be extracted from the application management database 314. In a case where the substitute items have been able to be extracted, the use support processor 324 specifies the desirable measurement items not included in the measurement items specified in step S12, among the desirable measurement items, and determines whether the substitute items have been set for all the specified desirable measurement items. In a case where the substitute items have been set, the use support processor 324 determines whether all the set substitute items are included in the measurement items specified in step S12.

In a case where the above conditions are all satisfied, the use support processor 324 determines that the measurement items are sufficient by the use of the substitute items and executes the process in step S18. On the other hand, in a case where any one of the conditions is not satisfied, the use support processor 324 determines that the measurement items are not sufficient and executes the process in step S17.

[step S17] The use support processor 324 extracts, from the application management database 314, the related application set for the production support program specified in step S13. The use support processor 324 confirms whether the auxiliary program capable of creating the measurement value of the desirable measurement item determined as insufficient from the measurement value of the other measurement item specified in step S12 is included in the program extracted as the related application. In a case where an appropriate auxiliary program is determined as that included in this process, information indicating the auxiliary program is included in the process result output in step S19.

[step S18] The use support processor 324 extracts, from the application management database 314, the precision condition set for the production support program specified in step S13. Then, the use support processor 324 determines whether the next conditions are satisfied.

The use support processor 324 first determines whether the precision condition has been able to be extracted from the application management database 314. In a case where the precision condition has been able to be extracted, the use support processor 324 determines whether the measurement values of the user corresponding to all the desirable measurement items for which the precision condition is set satisfy the precision condition. In a case where it is determined that there is the substitute item corresponding to the desirable measurement item in step S16, whether the measurement value of the user corresponding to the substitute item satisfies the precision condition is also determined.

In a case where all the above conditions are satisfied, the use support processor 324 determines that the user can use the production support program specified in step S13, and executes the process in step S19. On the other hand, in a case where any one of the above conditions is not satisfied, the use support processor 324 executes the process in step S17.

Note that the precision of the measurement value may be acquired and may not be acquired from the measurement condition of the record acquired in step S11. For example, in the case of the production support program #4 illustrated in FIG. 14, the desirable measurement items are the input time, the completion time of a step and the alarm occurrence time, and the precision condition is the acquisition intervals of the measurement values of the aforementioned times being 1 minute or less. In this case, in a case where the acquisition intervals of the desirable measurement items are set in the measurement condition of the record acquired in step S11, the use support processor 324 determines whether the precision condition is satisfied on the basis of the set acquisition intervals.

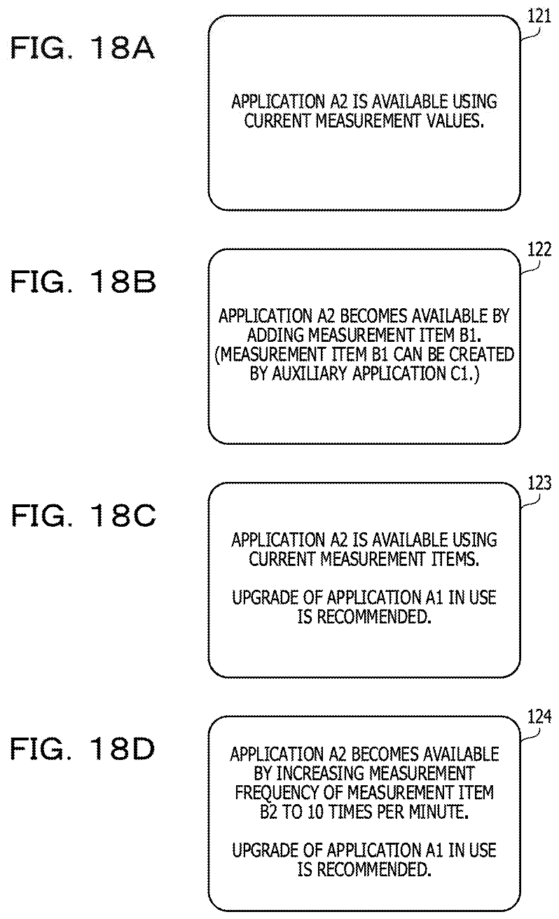

Meanwhile, in the case of the production support program #5 illustrated in FIGS. 15A and 15B, for example, the desirable measurement items the mounting position of a component and the precision condition is the index (here, the variance) indicating the variation of the mounting position being a fixed value or less. In this case, in a case where the variance of the mounting position is not set in the measurement condition of the record acquired in step S11, the use support processor 324 calculates the variance of the measurement value of the acquired each record and determines whether the calculated variance satisfies the precision condition.

[step S19] The use support processor 324 transmits the process result of the above process to the production management server 110 of the user and causes the terminal device 120 to display the process result. Here, examples of the process result are illustrated in FIGS. 18A to 18D.

FIGS. 18A to 18D are diagrams illustrating screen display examples on the terminal device in the first process example. First, FIGS. 18A and 18B illustrate examples of screens presented to the user who has not received the production support service

A screen 121 illustrated in FIG. 18A is an example of a screen in a case where a production support program of “application A2” is determined as available to the user in step S18 in FIG. 17. With the screen 121, the use support processor 324 can show the user that the production support program is available using the measurement values being currently measured and can recommend use of the production support program. For example, the use support processor 324 can present the user with a production support program that matches an environment of the production facility and production system on the user side.

A screen 122 illustrated in FIG. 18B is an example of a screen in a case where a measurement item 131 is determined as insufficient in step S15 in FIG. 17 and an auxiliary program of “auxiliary application C1” for creating the measurement item B1 is extracted in step S17. With the screen 122, the use support processor 324 can show the user that the production support program becomes available by newly measuring the measurement item 131 and can recommend use of the production support program. Furthermore, the use support processor 324 can show the auxiliary program for creating the measurement value of the insufficient measurement item 131 to the user and can recommend use of the production support program.

Here, in the process for creating the information as in FIGS. 18A and 18B, determination is made using the precision condition and the substitute item. With the determination, the accuracy of the information to be provided can be improved.

Further, the production support server 380 can facilitate use of the production support program by showing the available production support program and the method for making the production support program available to the user. Here, the production support server 300 analyzes a huge amount of the production managment data accumulated on the user side and provides the above information to the user as a result of the analysis. With the provision, the provider of the production support service can easily recommend many users use of the production support program on the basis of the huge amount of data, which may not be manually analyzed. Therefore, the use of the production support program can be facilitated at low cost.

Next, FIGS. 18C and 18D illustrate a case in which the user is currently using a production support program of “application A1” and a production support program of “application A2” that is an upgraded version of the application A1 is specified in step S13 in FIG. 17.

A screen 123 illustrated in FIG. 18C is an example of a screen in a case where the new production support program of “application A2” is determined as available by the user in step S18 in FIG. 17. With the screen 123, the use support processor 324 can show the user that the new production support program is available and can recommend use of the production support program.

A screen 124 illustrated in FIG. 18D is an example of a screen in a case where the measurement value of a measurement item B2 that is a desirable measurement item is determined not to satisfy the precision condition of the measurement frequency being 10 times per minute or more in step S18 in FIG. 17. With the screen 124, the use support processor 324 can show the user that the new production support program becomes available by increasing the measurement frequency of the measurement item B2 and can recommend use of the production support program.

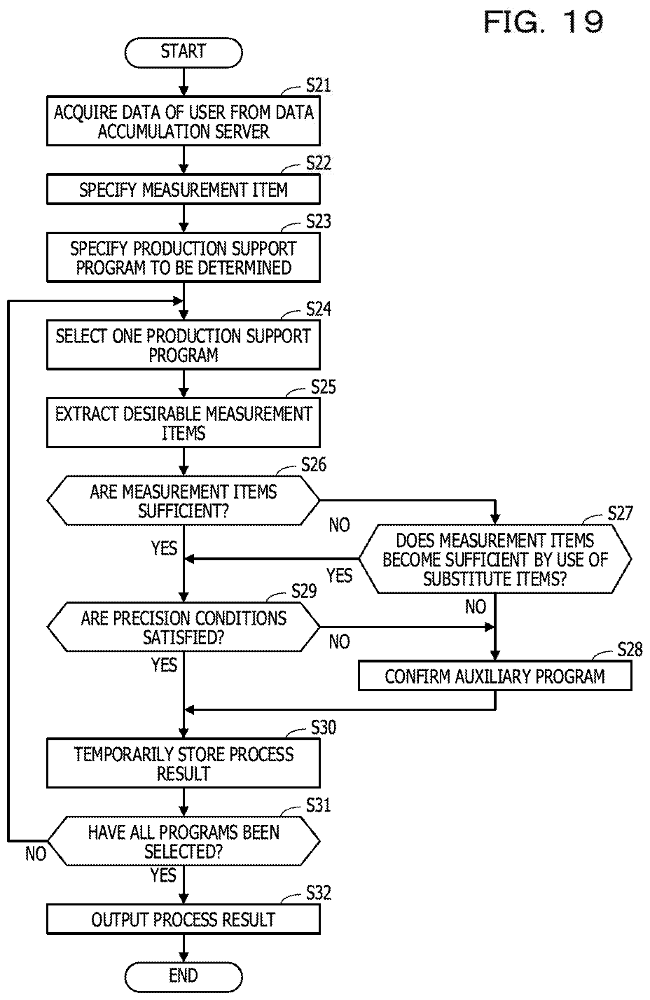

FIG. 19 is a flowchart illustrating a second process example in the use support service. This second process example illustrates a process in the use support service for extracting a production support program available to a specific user from among a plurality of production support programs and presenting the extracted production support program to the user.

[step S21] The use support processor 324 selects the user to which a service is to be provided according to a similar procedure to step S11 in FIG. 17 and acquires the production management data corresponding to the selected user from the data accumulation server 200 via the data acquirer 323.

[step S22] The use support processor 324 specifies the measurement items measured by the production management server 110 of the user in a similar procedure to step S12 in FIG. 17.

[step S23] The use support processor 324 specifies one or more production support programs to be determined in step S24 and subsequent steps from among the production support programs. For example, the use support processor 324 designates an attribute to specify the production support program corresponding to the attribute. As the attribute, for example, an attribute indicating what kind of technology the production support program is applied to or indicating what kind of effect is produced by execution of the production support program.

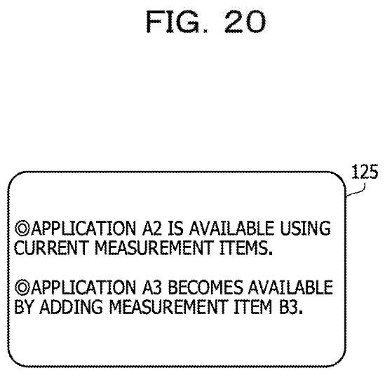

In step S22, in a case where the user has already received the production support service, a production support program other than the production support program currently being used by the user is specified on the basis of the user management database 313.

[step S24] The use support processor 324 selects one production support program to be processed from among the production support programs specified in step S23.

[steps S25 to S29] The use support processor 324 executes a similar process to steps S14 to S18 in FIG. 17 with the production support program selected in step S24 as an object to be processed.

[step S30] The use support processor 324 temporarily stores a process result of steps S24 to S29 in the storage area. This process result indicates whether the production support program selected in step S24 is available to the user. Further, in a case where the process result is not available, the process result indicates that the production support program selected in step S24 becomes available to the user by adding the measurement item or improving the precision of the measurement value of the desirable measurement item. Furthermore, the process result indicates that the auxiliary program for creating the measurement value of the measurement item exists in a case where the measurement item is not sufficient.

[step S31] The use support processor 324 determines whether all the production support programs specified in step S23 have been selected as the objects to be processed. In a case where all of the production support programs have been selected, the use support processor 324 executes the process in step S32. On the other hand, in a case where there is an unselected production support program, the use support processor 324 executes the process in step S24 to select the unselected production support program.

[step S32] The use support processor 324 creates a final process result on the basis of the process result stored in step S30, transmits the process result to the production management server 110 of the user, and causes the terminal device 120 to display the process result. Here, an example of the process result is illustrated in FIG. 20.

FIG. 20 is a diagram illustrating a screen display example on the terminal device in the second process example. A screen 125 illustrated in FIG. 20 indicates that the production support program of “application A2” is available to the user, using the measurement items being currently measured. By providing such information to the user, a production support program that matches an environment of the production facility and production system on the user side can be presented to the user. Furthermore, the screen 125 indicates that another production support program “application A3” becomes available by newly measuring a measurement item B3. By providing such information to the user, use of the production support program can be facilitated.

### Third Embodiment

In the above-described second embodiment, whether the production support program is available to the user is determined on the basis of the desirable measurement items registered in advance in the application management database 314. However, not all the desirable measurement items registered in advance are referenced when the production support program is actually executed. In that case, the production support program is determined as unavailable to the user in a case where the production management server 110 of the user has not measured the measurement value of a desirable measurement item not actually used. For this reason, a production support program that is likely to be actually available may not be provided to the user, and an opportunity for the user to use the production support program is lost. Therefore, disadvantages occur on the service provider side and on the user side.

Therefore, in a third embodiment, the process of the production support server 300 in the second embodiment is modified as follows. A production support server of the third embodiment accumulates history information regarding used measurement items at execution time of a production support program. Then, when recommending a user a certain production support program, the production support server determines whether the production support program is available to the user, using an actually used measurement item from the history information as a desirable measurement item.

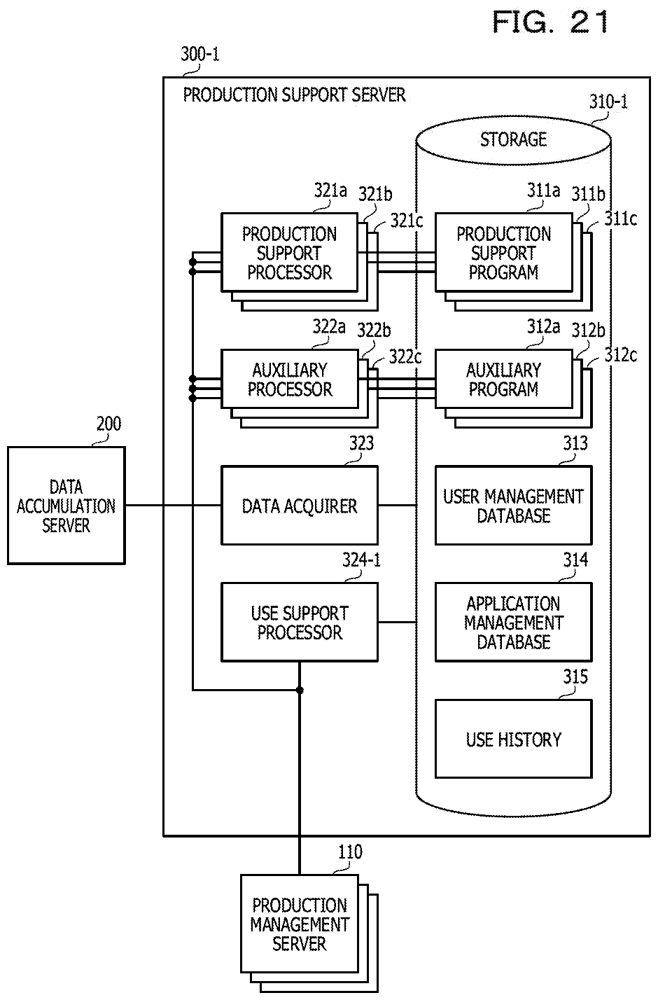

FIG. 21 is a diagram illustrating a configuration example of process functions provided in the production support server of the third embodiment. In FIG. 21, the same constituent elements as in FIG. 8 are denoted by the same reference numerals.

A production support server 300-1 illustrated in FIG. 21 includes a storage 310-1 in place of the storage 310 illustrated in FIG. 8. A use history 315 is stored in the storage 310-1 in addition to the information stored in the storage 310. In the use history 315, histories of measurement items used (referred to) by production support processors 321a, 321b, 321c, and the like at execution time of production support programs 311a, 311b, 311c, and the like are registered.

Further, the production support server 300-1 includes a use support processor 324-1 in place of the use support processor 324 in FIG. 8. The use support processor 324-1 determines the desirable measurement items corresponding to the production support program on the basis of the use history 315 and determines whether the production support program is available to the user using the determined desirable measurement items.

Note that the process of the use support processor 324-1 is realized by, for example, execution of a predetermined program by a processor provided in the production support server 300-1.

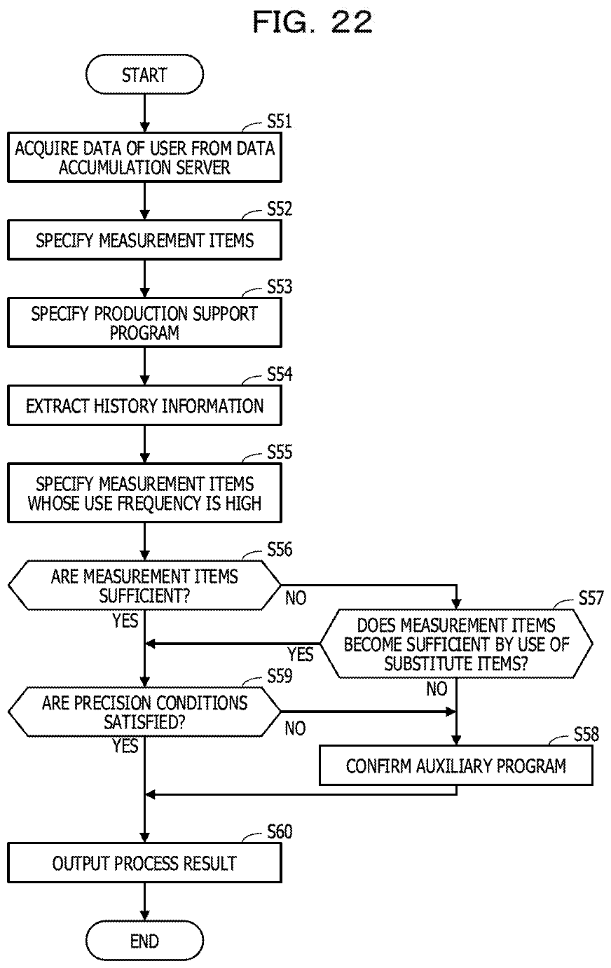

FIG. 22 is a flowchart illustrating a process example in the production support service.

[steps S51 to S53] The use support processor 324-1 executes a similar process to steps S11 to S13 in FIG. 17.

[step S54] The use support processor 324-1 extracts, from the use history 315, the history information registered at the execution time of the production support program specified in step S53. In this process, the history information registered when providing the production support service to other users is extracted.

[step S55] The use support processor 324-1 specifies measurement items whose use frequency is a fixed value or more from the used measurement items as the desirable measurement items on the basis of the extracted use history.

Note that this step S55 may be skipped. In that case, the desirable measurement items used in steps S56 to S59 are all the measurement items included in the history information extracted in step S54.

[step S56 to S59] The use support processor 324-1 executes a similar process to, steps S15 to S18 in FIG. 17 using the desirable measurement items specified in step S55.

[step S50] The use support processor 324-1 transmits a process result of the above process to the production management server 110 of the user and causes the terminal device 120 to display the process result in a similar procedure to step S19 in FIG. 17.

According to the third embodiment, whether the production support program is available to the user or how to make the production support program available is determined using the measurement items actually used at the execution time of the production support program as the desirable measurement items. As a result, accurate determination can be made to fit the actual usage of the measurement value.

### Fourth Embodiment

As described above, not all the desirable measurement items registered in advance in the application management database 314 are referenced when the corresponding production support program is actually executed. On the contrary, a measurement item whose actual use frequency is high and which is considered to be useful to be set as a desirable measurement item may exist among measurement items set as other measurement items.

Therefore, in a fourth embodiment, a following developer support service for a developer of a production support program is provided. In this service, an unpreferable measurement item among desirable measurement items set for the production support program and measurement items to be newly added as the desirable measurement items are notified to the developer on the basis of an actual use status of the production support program.

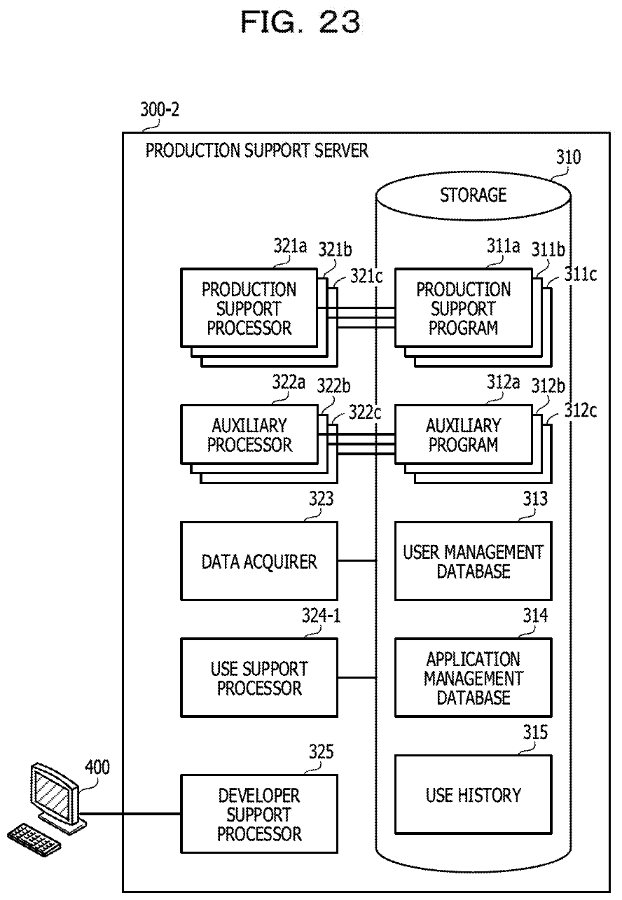

FIG. 23 is a block diagram illustrating a configuration example of process functions provided in a production support server of the fourth embodiment. In FIG. 23, the same constituent elements as in FIG. 21 are denoted by the same reference numerals.

A production support server 300-2 illustrated in FIG. 23 further includes a developer support processor 325 in addition to, the process functions, of the production support server 300-1 in FIG. 21. The developer support processor 325 is connected to a developer terminal 400 operated by the developer of the production support program. The developer support processor 325 extracts history information registered at execution time of a certain production support program from a use history 315, and calculates a use frequency of a measurement item on the basis of the extracted history information. The developer support processor 325 determines whether there are unpreferable measurement items among the desirable measurement items set for the production support program and whether there are measurement items to be added as the desirable measurement items on the basis of the calculated use frequency. Then, the developer support processor 325 transmits a determination result to the developer terminal 400 to notify the developer of content of the determination result.

Note that the process of the developer support processor 325 is realized by, for example, execution of a predetermined program by a processor provided in the production support server 300-2.

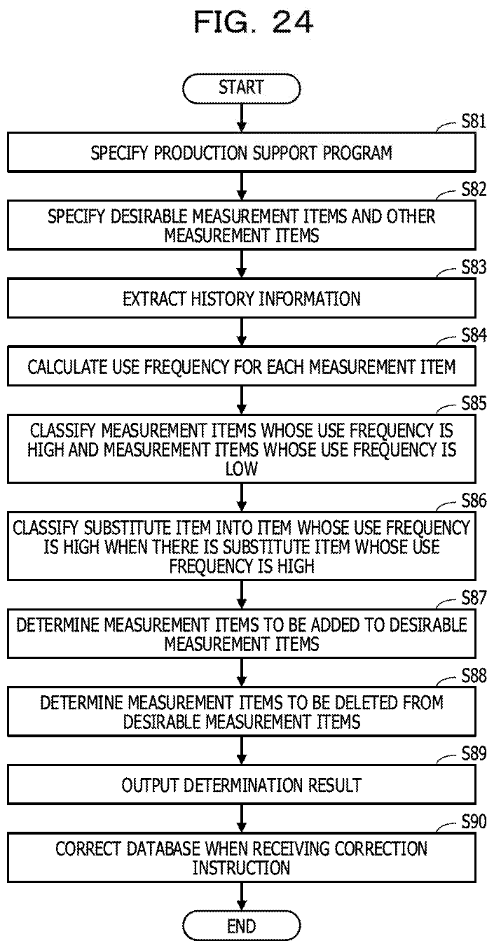

FIG. 24 is a flowchart illustrating a process example in a developer support service.

[step S81] The developer support processor 325 specifies the production support program to be processed.

[step S82] The developer support processor 325 refers to an application management database 314 to specify the desirable measurement items and other measurement items set for the production support program specified in step S81.

[step S83] The developer support processor 325 extracts, from the use history 315, the history information registered at the execution time of the production support program specified in step S81.

[step S84] The developer support processor 325 specifies the measurement items used at the execution time of the production support program specified in step S81 on the basis of the extracted history information. Then, the developer support processor 325 calculates the use frequencies of the specified respective measurement items. The use frequency is calculated by dividing the number of referred times of measurement data of the measurement item by a time in which the production support program is executed, for example.

[step S85] The developer support processor 325 classifies the measurement items specified in step S84 into measurement items whose use frequency is high and measurement items whose use frequency is low. This classification is performed by comparing the use frequency with a predetermined threshold value, and the use frequency is determined as high in a case where the use frequency is the threshold value or larger and the use frequency is determined as low in a case where the use frequency is less than the threshold value.

[step S86] The developer support processor 325 refers to the application management database 314 and extracts a measurement item for which a substitute item has been set among the measurement items determined as those of a low use frequency in step S85. In a case where the measurement item for which the substitute item has been set and the use frequency of the set substitute item exceeds the above-described threshold value, the developer support processor 325 reclassifies the measurement item into the measurement item whose use frequency is high.

By the process in step S86, in a case the use frequency of the corresponding substitute item is high even in a case where the actual use frequency of the measurement item set as the desirable measurement item is low, the original measurement item is maintained as the desirable measurement item.

[step S87] The developer support processor 325 extracts measurement items not included in the desirable measurement items specified in step S82 from among the measurement items determined as those of a high use frequency in steps S85 and S86. The developer support processor 325 determines that the extracted measurement items are measurement items to be added to the desirable measurement items.

[step S88] The developer support processor 325 extracts, from the desirable measurement items specified in step S82, the measurement items determined as those of a low use frequency in steps S85 and S86. The developer support processor 325 determines that the extracted measurement items are measurement items to be deleted from the desirable measurement items.

[step S89] The developer support processor 325 transmits determination results in steps S87 and S88 to the developer terminal 400 and causes the developer terminal 400 to display the determination results.

[step S90] In a case where correction of the application management database 314 is requested from the developer terminal 400 according to an operation of the developer, the developer support processor 325 corrects the application management database 314 on the basis of the determination results in steps S87 and S88.

For example, the developer support processor 325 specifies a record corresponding to the production support program specified in step S81 among records in the application management database 314. The developer support processor 325 deletes the measurement items determined as those to be deleted in step S88 among the desirable measurement items registered in the specified record, and adds the deleted measurement items as other measurement items. Further, the developer support processor 325 adds the measurement items determined as those to be added in step S87 as the desirable measurement items in the specified record, and deletes the added measurement items from the other measurement items.

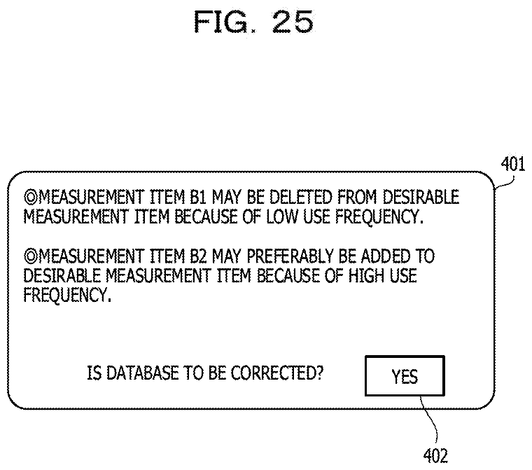

FIG. 25 is a diagram illustrating a screen display example on the developer terminal by the developer support service. A screen 401 illustrated in FIG. 25 illustrates a case in which a measurement item B1 is determined as that to be deleted from the desirable measurement item in step S88 in FIG. 24 and a measurement item B2 is determined as that to be added as the desirable measurement item in step S87. On the screen 401, the measurement item to be deleted from the desirable measurement item and the measurement item to be added as the desirable measurement item are notified to the developer as an analysis result of a data use status at the execution time of the production support program. The developer can use the notified information in developing a future production support program and maintaining the current production support service. Therefore, the process by the developer support processor 325 can improve the development efficiency by the developer and the work efficiency of maintenance.

Further, on the screen 401, a button 402 for requesting correction of the application management database 314 is displayed. When a selection operation on the button 402 is performed by the developer, correction of the application management database 314 is requested to the production support server 300-2. In response to the request, the process in step S90 in FIG. 24 is executed, and information of the desirable measurement items and the other measurement items in the record of the appropriate production support program is updated.

With the update, only the data items with a high possibility of being actually used at the execution time of the production support program are registered as the desirable measurement items, and use conditions of the production support program are optimized to match the usage of the user. As a result, a probability that the user who can benefit from the use of the production support program uses the production support program becomes high and the use is facilitated.

Further, for example, a screen obtained by removing the button 402 from the screen 401 may be displayed on a terminal device of a manager of the production support program In this case, the manager can perform a setting change operation of the application management database 314 on the basis of the displayed screen.

Note that the process functions of the apparatuses described in the above embodiments (for example, the program management apparatus 1 and the production support servers 300, 300-1, and 300-2) can be realized by a computer. In that case, a program describing the process content of the functions to be held by each apparatus is provided, and the above process functions are realized on the computer by execution of the program on the computer. The program describing the process content can be recorded on a computer-readable recording medium. Examples of the computer-readable recording medium include a magnetic storage device, an optical disc, a magneto-optical recording medium, and a semiconductor memory. Examples of the magnetic storage device include a hard disk drive (HDD), a flexible disk (FD), and a magnetic tape. Examples of the optical disc include a digital versatile disc (DVD), a DVD-RAM, a compact disc-read only memory (CD-ROM), and a CD-recordable (R)/rewritable (RW). An example of the magneto-optical recording medium includes a magneto-optical (MO) disk.

In a case where the program is to be distributed, for example, portable recording media such as DVDs and CD-ROMs, in which the program is recorded, are sold. Alternatively, the program may be stored in a storage device of a server computer, and the program may be transferred from the server computer to another computer via a network.

The computer that executes the program stores the program recorded on the portable recording medium or the program transferred from the server computer in its own storage device, for example. Then, the computer reads the program from its own storage device and executes a process according to the program. The computer can also read the program directly from the portable recording medium and execute the process in accordance with the program. Further, the computer can also execute the process according to the received program each time the program is transferred from the server computer connected via the network.

The above description merely describes the principle of the present invention Furthermore, numerous modifications and variations are able to be made by those skilled in the art, and the present invention is not limited to the above-described or illustrated exact configuration and application example, and all corresponding modifications and equivalents are regarded to fall within the scope of the present invention by appended claims and equivalents thereof.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention. What is claimed is:

1. A non-transitory computer-readable recording medium having stored therein a program management program for causing a computer to execute processes comprising:
referring to a storage indicating an execution status of a production support program which is executed using production management data;
specifying one or more data items which correspond to a data item not used at execution time of the production support program or a data item whose frequency of use at the execution time of the production support program is a predetermined reference value or less, among data items included in the production management data; and
outputting the specified one or more data items.

2. The non-transitory computer-readable recording medium according to claim 1, wherein the program management program further comprises
in the outputting, outputting information for recommending deletion of the specified one or more data items or change of management information regarding the specified one or more data items, from the management information in which data items to be used at the execution time of the production management data are registered in advance.

3. The non-transitory computer-readable recording medium according to claim 2, wherein the program management program causes the computer to further execute a process comprising:
determining whether a substitute data item that substitutes for at leas one of the specified one or more data items is set, wherein
a result of the determining is included in an execution condition of the deletion of the specified one or more data items or the change of the management information in the outputting.

4. The non-transitory computer-readable recording medium according to claim 1, wherein the program management program further comprises
when, with respect to a first data item in the specified one or more data items, a second data item for substituting for the first data item is set, referring to the storage and excluding the second data item from the data item to be output in the outputting, in a case where the second data item has been used at the execution time of the production support program, or in a case where a frequency of use of the second data item exceeds the reference value at the execution time of the production support program.

5. The non-transitory computer-readable recording medium according to claim 1, wherein
the specifying includes specifying a data item used at the execution time of the production support program or a data item whose frequency of use at the execution time of the production support program exceeds the reference value, as a use data item, among the data items included in the production management data, and
in the outputting, the specified one or more data items and the use data item are distinguishably output.

6. A non-transitory computer-readable recording medium having stored therein a program management program for causing a computer to execute processes comprising:
referring to a storage indicating an execution status of a production support program which is executed using production management data;
specifying a data item used at execution time of the production support program or a data item whose frequency of use at the execution time of the production support program exceeds a predetermined reference value, among data items included in the production management data; and
outputting the specified data item.

7. The non-transitory computer-readable recording medium according to claim 6, wherein the program management program further comprises
in the outputting, outputting information for recommending addition of the specified data item or change of management information regarding the data item, with respect to the management information in which data items to be used at the execution time of the production management data are registered in advance.

8. A information processing apparatus comprising:
a memory configured to store an execution status of a production support program which is executed using production management data; and
a processor configured to
refer to the storage;
specify, from among data items included in the production management data, and outputs the specified data item, a first data item which is one of a data item which is not used at execution time of the production support program and a data item whose frequency of use at the execution time of the production support program is a predetermined reference value or less or a second data item which is one of a data item which is used at execution time of the production support program and a data item whose frequency of use at the execution time of the production support program exceeds the predetermined reference value; and
output the specified data item.
